(19) United States
(12) Patent Application Publication
(10) Pub. No.: US 2019/0047359 A1
(43) Pub. Date: Feb. 14, 2019

(54) APPARATUS AND METHOD FOR DIRECT HEAT EXCHANGE BETWEEN EXHAUST GASES AND CABIN AIR OF A MOTOR VEHICLE

(71) Applicant: FORD GLOBAL TECHNOLOGIES, LLC, Dearborn, MI (US)

(72) Inventor: Jonathan Garza Bennet, Cuautitlan Izcalli (MX)

(21) Appl. No.: 15/675,527

(22) Filed: Aug. 11, 2017

(51) Int. Cl. B60H 1/00; B60H 1/18; B60H 1/02

(52) U.S. Cl. CPC B60H 1/00885; B60H 1/025; B60H 1/18

(57) ABSTRACT

An apparatus includes an exhaust gas and cabin air heat exchanger having an exhaust gas inlet, an exhaust gas outlet, a cabin air inlet and a cabin air outlet whereby heat is directly exchanged between exhaust gases and cabin air of a motor vehicle. A related method of heating cabin air in a motor vehicle is also disclosed.

### TECHNICAL FIELD

This document relates generally to the motor vehicle equipment field and, more particularly, to a new and improved apparatus and method provided for the direct heat exchange between exhaust gases and cabin air in a motor vehicle.

### BACKGROUND

Internal combustion engines transform only a fraction of the total energy from fuel to mechanical energy. The remainder is lost as heat to the engine coolant and exhaust gases.

Common motor vehicle cabin heating devices rely upon heat exchange between the engine coolant and the cabin air in order to heat the passenger cabin. When a motor vehicle has been resting in low ambient temperature conditions, the engine coolant cools to the ambient temperature. Unfortunately, it takes a significant amount of time for the engine coolant to warm sufficiently to slowly heat the air being circulated through the passenger cabin. In addition, it should be appreciated that the removal of this heat energy from the engine coolant slows the process of engine warmup, which in turn increases fuel consumption and lowers fuel economy.

The new and improved apparatus provides for direct heat exchange between the engine exhaust gases and the cabin air without the use of any other intermediate working fluid which would slow down the process of cabin heating. Advantageously, exhaust energy is taken downstream from the emission reduction devices, such as the catalytic converter, so as to not compromise the normal after-treatment warmup process and thereby maintain combustion gas emissions within desired design parameters.

### SUMMARY

In accordance with the purposes and benefits described herein, an apparatus is provided for the direct exchange of heat between exhaust gases and cabin air in a motor vehicle. That apparatus comprises a heat exchanger having an exhaust gas inlet, an exhaust gas outlet, a cabin air inlet and a cabin air outlet.

That apparatus may further include an exhaust gas inlet conduit having a first end connected to an exhaust gas conduit and a second end connected to the exhaust gas inlet. Further, the apparatus may include an exhaust gas flow control valve at the first end.

The apparatus may further include an exhaust gas discharge conduit connected to the exhaust gas outlet. In addition, the apparatus may further include a cabin air inlet conduit connected to the cabin air inlet and a cabin air outlet conduit connected to the cabin air outlet.

Still further, the apparatus may include a cabin air circulation fan that circulates air through the cabin air inlet conduit, the heat exchanger and the cabin air outlet conduit.

Still further, the apparatus may include a controller. That controller may be configured to control operation of the exhaust gas flow control valve. In addition, the controller may be further configured to control operation of the cabin air circulation fan.

The apparatus may also include a cabin temperature monitor and an exhaust gas temperature monitor. Both of these monitors may be connected to the controller. In addition, in some embodiments the exhaust gas flow control valve may be connected downstream of a catalytic converter of the motor vehicle.

Some embodiments may also include a coolant and cabin air heat exchanger in addition to the exhaust gas and cabin air heat exchanger. In such an embodiment, the controller may control operation of both heat exchangers in a manner that maximizes the heating efficiency for the motor vehicle.

In accordance with yet another aspect, a method is provided for heating cabin air in a motor vehicle. That method comprises circulating exhaust gases and cabin air through a heat exchanger whereby heat is directly exchanged between the exhaust gases and the cabin air without the use of any other working fluid.

The method may further include the step of diverting exhaust gases toward the heat exchanger by operation of an exhaust gas flow control valve. In addition, the method may include locating that exhaust gas flow control valve downstream from a catalytic converter of the motor vehicle.

Still further, the method may include the step of configuring a controller to control operation of the exhaust gas flow control valve. In addition the method may include the step of circulating cabin air through the heat exchanger with a cabin air circulation fan. In such an embodiment the controller may be further configured to control operation of the cabin air circulation fan.

Still further, the method may include the step of exclusively heating the cabin air with exhaust gases in the heat exchanger. In other embodiments the method may include pairing the exhaust gas and cabin air heat exchanger with a motor vehicle coolant and cabin air heat exchanger. In such an embodiment the method may also include the step of configuring the controller to heat the cabin air with (a) exhaust gases in the exhaust gas and cabin air heat exchanger until the motor vehicle coolant reaches a predetermined temperature and (b) the motor vehicle coolant in the motor vehicle coolant and cabin air heat exchanger after the coolant reaches the predetermined temperature.

In the following description, there are shown and described several preferred embodiments of the apparatus and method. As it should be realized, the apparatus and method are capable of other, different embodiments and their several details are capable of modification in various, obvious aspects all without departing from the apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and method for direct heat exchange between exhaust gases and cabin air in a motor vehicle and together with the description serve to explain certain principles thereof.

FIG. 1 is a schematic illustration of the exhaust gas circuit of the apparatus.

FIG. 2 corresponds to FIG. 1 but illustrates the undiverted and normal flow of exhaust gases from the engine of the motor vehicle.

FIG. 3 is a view similar to FIG. 1 but illustrating operation of the exhaust gas flow control valve diverting 100% of the exhaust gases from the engine to the exhaust gas and cabin air heat exchanger.

FIG. 4 is a view similar to FIG. 1 but illustrating the exhaust gas flow control valve in an intermediate position wherein the flow of exhaust gases is split between the normal flow path and the exhaust gas and cabin air heat exchanger.

FIG. 5 is a detailed schematic view of the exhaust gas and cabin air heat exchanger.

FIG. 6 is a schematic illustration of an alternative embodiment wherein the apparatus includes both an exhaust gas and cabin air heat exchanger and an engine coolant and cabin air heat exchanger.

FIG. 7 is a schematic block diagram illustrating the control circuitry for the apparatus.

Reference will now be made in detail to the present preferred embodiments of the exchanger, examples of which are illustrated in the accompanying drawing figures.

### DETAILED DESCRIPTION

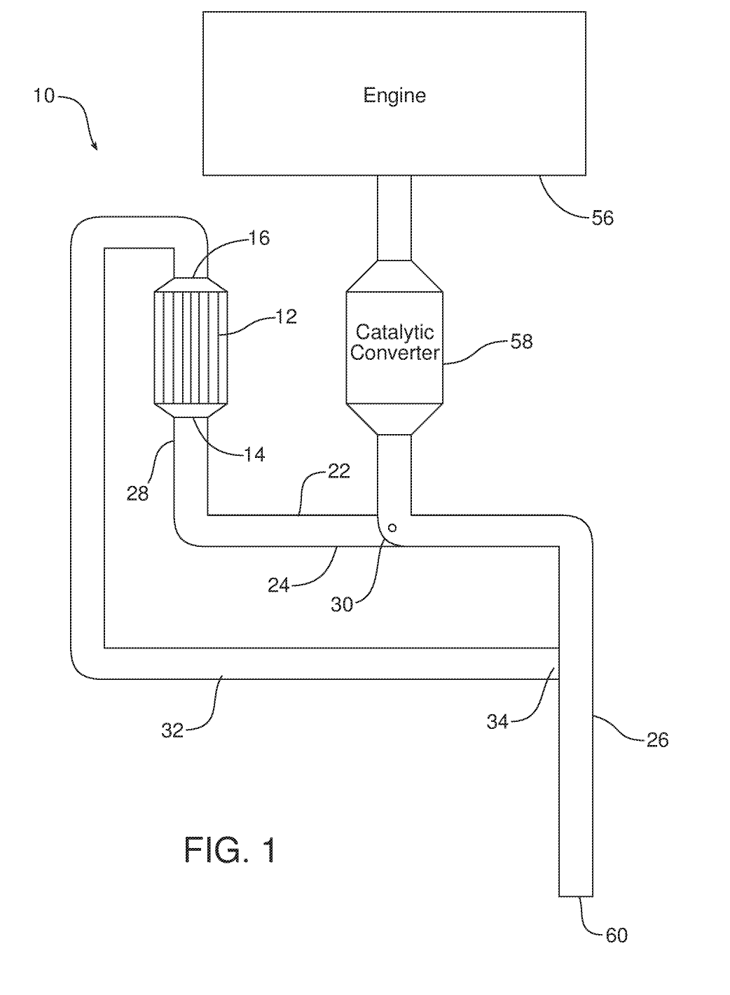

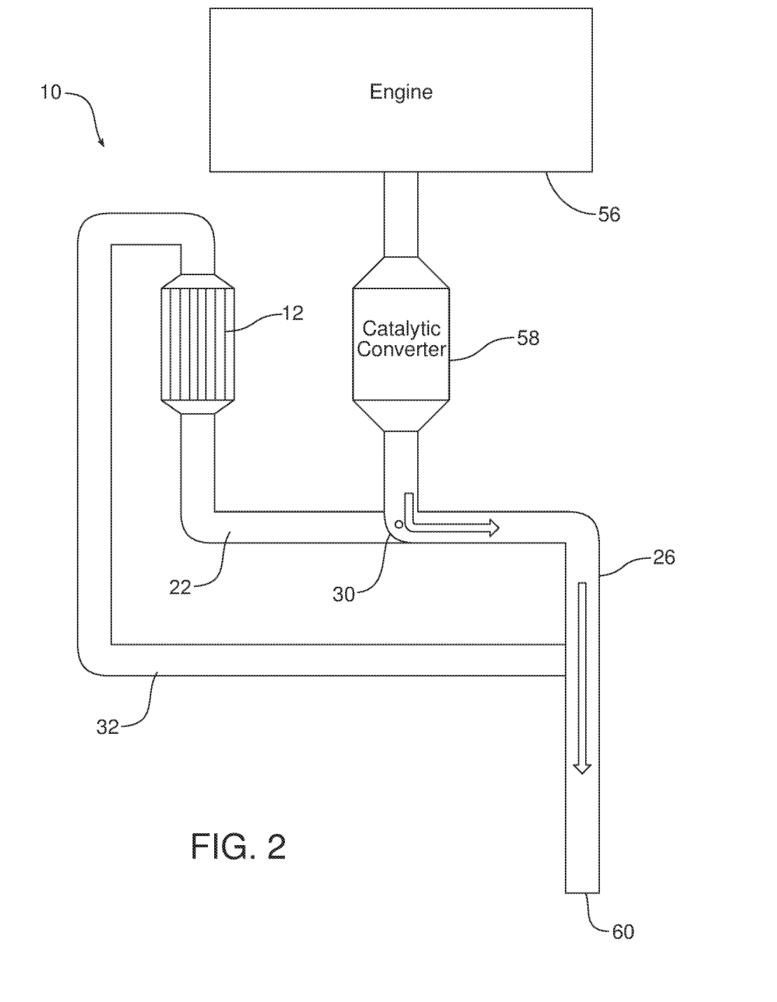

Reference is now made to FIGS. 1-4, 5 and 7 illustrating a first embodiment of a new and improved apparatus 10 adapted to provide direct heat exchange between exhaust gases and cabin air of a motor vehicle. Advantageously, the elimination of any intermediate working fluid in the heat exchange process between the exhaust gases and the cabin air ensures the most rapid and efficient heating of the cabin air thereby allowing for faster warming of the passenger cabin of a motor vehicle particularly after resting for an extended period of time in low ambient temperatures/winter weather conditions.

The apparatus 10 includes an exhaust gas and cabin air heat exchanger 12 having an exhaust gas inlet 14, an exhaust gas outlet 16, a cabin air inlet 18 and a cabin air outlet 20 whereby heat is directly exchanged between exhaust gases and cabin air of a motor vehicle.

As illustrated in FIG. 1, the apparatus 10 also includes an exhaust gas inlet conduit 22 having a first end 24 connected to the exhaust gas conduit 26 of a motor vehicle. A second end 28 of the exhaust gas inlet conduit 22 is connected to the exhaust gas inlet 14. The apparatus 10 further includes an exhaust gas flow control valve 30 at the first end 24 where the exhaust gas inlet conduit 22 is connected to the exhaust gas conduit 26.

The apparatus 10 also includes an exhaust gas discharge conduit 32 connected to the exhaust gas outlet 16. In the illustrated embodiment, the exhaust gas discharge conduit 32 has a discharge end 34 connected to the exhaust gas conduit 26. A one-way flow control valve (not shown) may be provided in the exhaust gas discharge conduit 32 such as adjacent the discharge end 34. Such a one-way flow control valve ensures the flow of exhaust gases from the exhaust gas discharge conduit 32 into the exhaust gas conduit 26 of the motor vehicle.

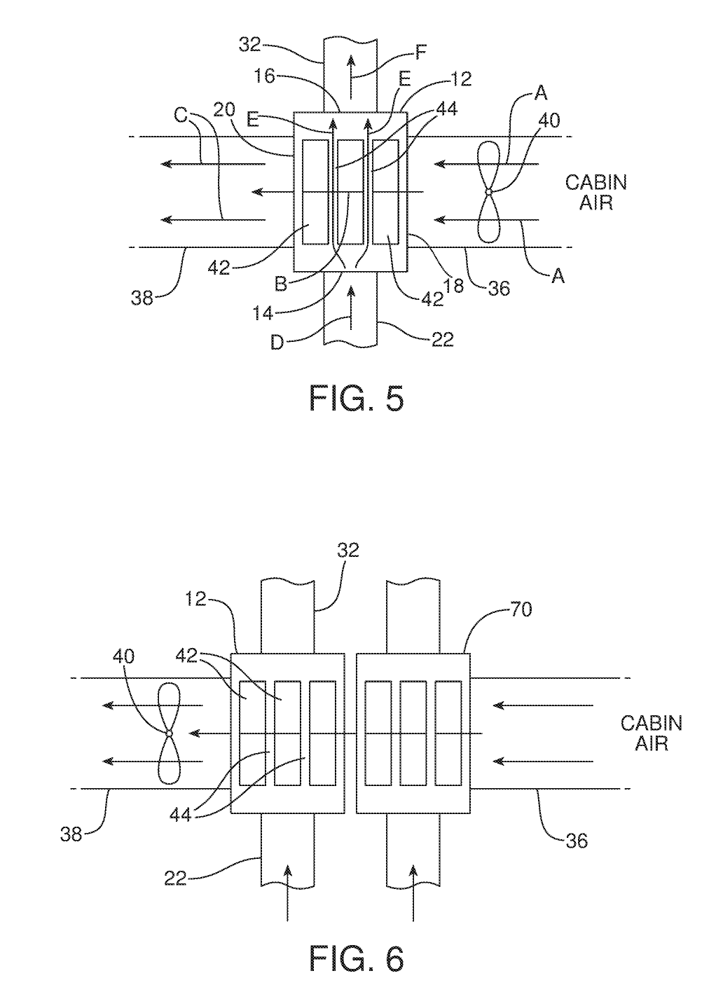

As best illustrated in FIG. 5, the apparatus 10 includes a cabin air inlet conduit 36 connected to the cabin air inlet 18 of the exhaust gas and cabin air heat exchanger 12 as well as a cabin air outlet conduit 38 connected to the cabin air outlet 20 of the exhaust gas and cabin air heat exchanger.

As further illustrated in FIG. 5, the apparatus 10 includes a cabin air circulation fan 40. In the illustrated embodiment, the cabin air circulation fan 40 is provided in the cabin air inlet conduit 36 and functions to circulate cabin air through the cabin air inlet conduit 36 (note action arrows A), the cabin air passageways 42 of the exhaust gas and cabin air heat exchanger 12 (note action arrow B) and the cabin air outlet conduit 38 (note action arrows C). Fresh air may also be delivered to the exhaust gas and cabin air heat exchanger 12 through the cabin air inlet conduit 36.

Exhaust gas flow (a) through the exhaust gas inlet conduit 22 is illustrated by action arrow D, (b) through the exhaust gas and cabin air heat exchanger 12 is illustrated by action arrows E and (c) through the exhaust gas discharge conduit 32 is illustrated by action arrow F. As should be appreciated, the cabin air circulation passageways 42 and the exhaust gas circulation passageways 44 of the exhaust gas and cabin air heat exchanger 12 are fully isolated from one another by walls of material having a high thermal conductivity to allow for efficient and effective heat exchange between the hot exhaust gases and the circulating cabin air to be heated by those hot exhaust gases.

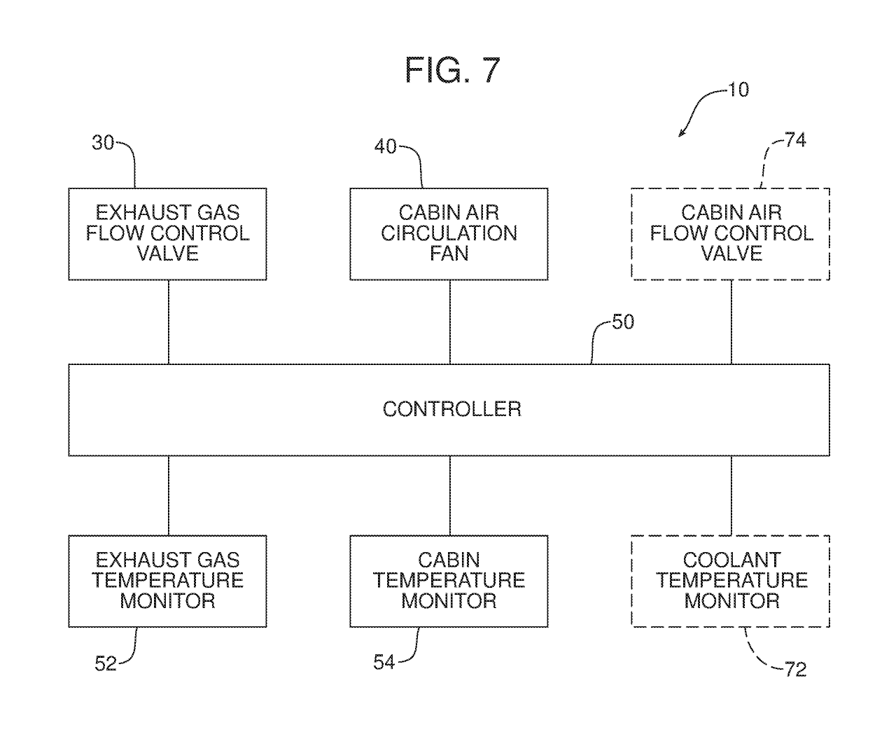

As best illustrated in FIG. 7, the apparatus 10 also includes a controller 50. The controller 50 may take the form of a computing device such as a dedicated microprocessor or an electronic control unit (ECU) operating in accordance with instructions from appropriate control software. Thus, the controller 50 may comprise one or more processors, one or more memories and one or more network interfaces all in communication with each other over a communication bus. The controller 50 is operatively connected to and is configured to control operation of the exhaust gas flow control valve 30 as well as the cabin air circulation fan 40.

As further illustrated in FIG. 7, the apparatus 10 may also include an exhaust gas temperature monitor 52 and a cabin air temperature monitor 54. As illustrated in FIG. 7, the exhaust gas temperature monitor 52 and the cabin air temperature monitor 54 are operatively connected to the controller 50 and provide the controller 50 with data respecting the exhaust gas temperature and the cabin air temperature. The controller 50 responds to that data to operate the exhaust gas flow control valve 30 and cabin air circulation fan 40 in an efficient and effective manner. Very precise control of the mass of exhaust gas flow through the heat exchanger 12 is achieved depending upon heating request, exhaust flow and exhaust temperature.

In summer or at other times when there is no request for heating the cabin air, the controller 50 sends a necessary signal to the actuator of the exhaust gas flow control valve 30 to cause that exhaust gas flow control valve to close off the inlet conduit 22 thereby routing 100% of the exhaust gas flow from the engine 56 and catalytic converter 58 upstream of that valve through the exhaust gas conduit 26 for discharge into the environment through the exhaust gas outlet 60. Thus, when the exhaust gas flow control valve 30 is in this position it should be appreciated that no heat is being exchanged with the cabin air in the exhaust gas and cabin air heat exchanger 12.

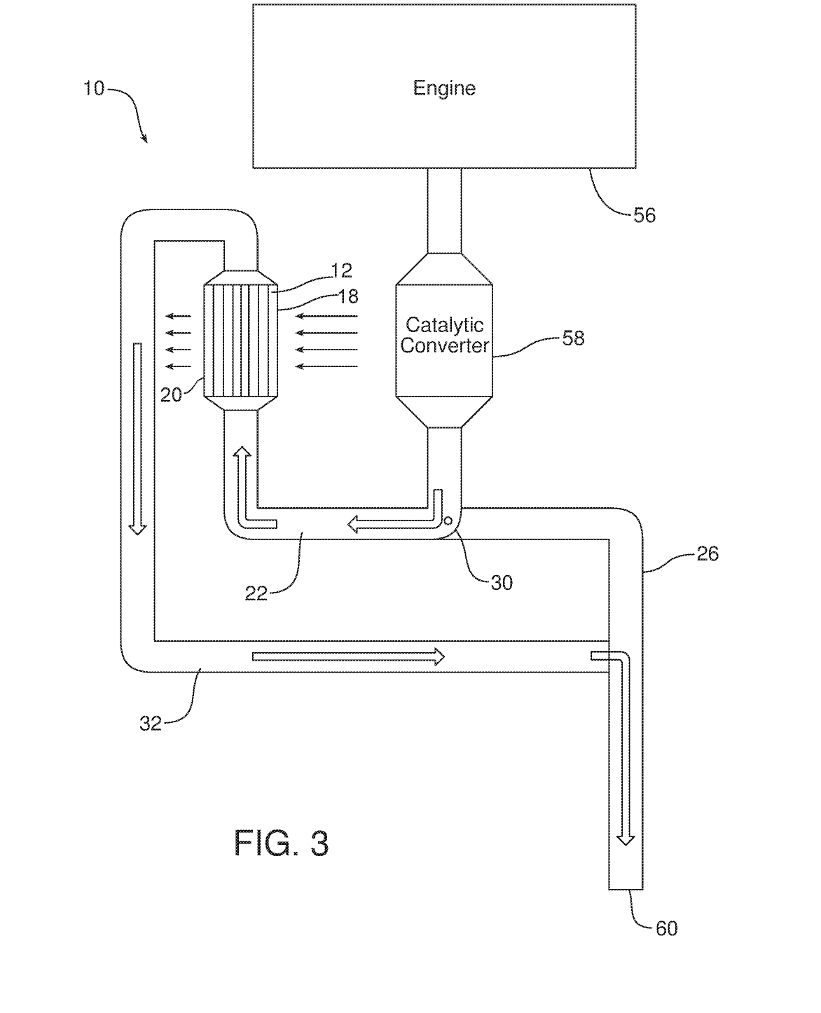

In contrast, when the cabin air temperature drops below a predetermined value or set point as indicated by the cabin air temperature monitor 54, the controller 50 responds to a heating request by adjusting the position of the exhaust gas flow control valve 30. As illustrated in FIG. 3, the exhaust gas flow control valve 30 has been fully opened to divert 100% of the exhaust gases from the upstream engine 56 and catalytic converter 58 through the exhaust gas inlet conduit 22 to the exhaust gas and cabin air heat exchanger 12. There, heat from the exhaust gas is transferred to the cabin air to warm the cabin for the comfort of the passenger cabin occupants. The fully opened position of the exhaust gas flow control valve 30 illustrated in FIG. 3 would be appropriate on a cold winter day when initially heating the cabin air with the exhaust gases. After heat exchange with the cabin air, those exhaust gases are discharged through the exhaust gas discharge conduit 32 back into the exhaust gas discharge conduit 32 and returned to the environment through the exhaust gas outlet 60. Advantageously, by providing for direct heat exchange between the exhaust gases and the cabin air and eliminating any intermediate working fluid, more rapid and responsive cabin air heating is possible.

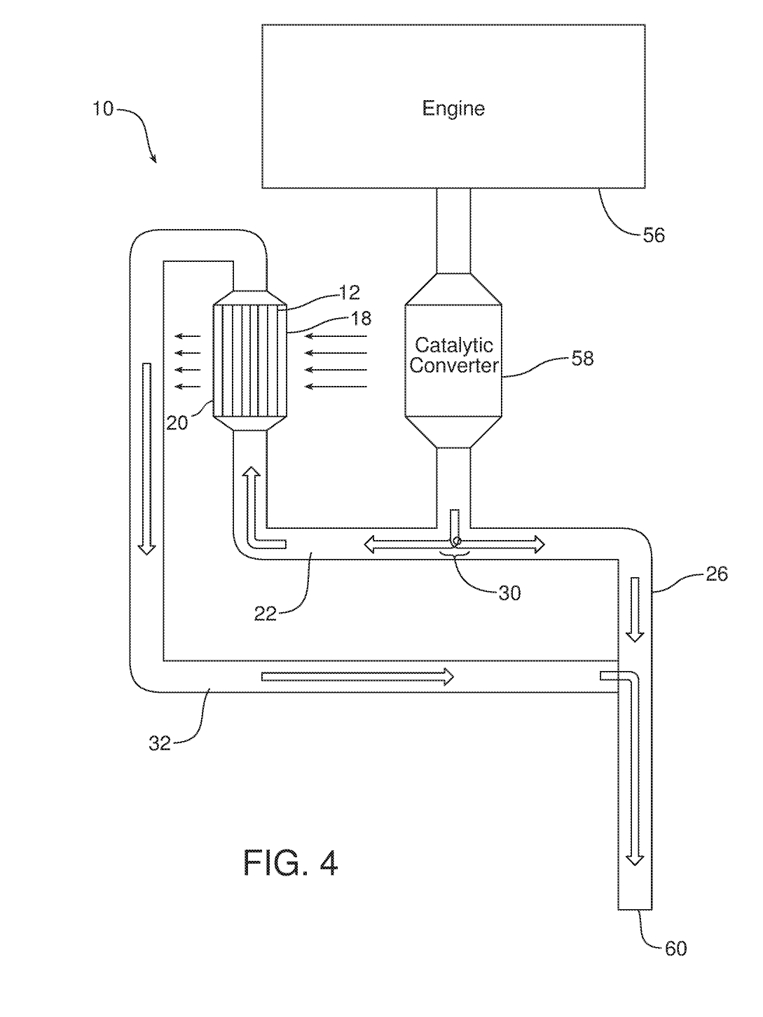

After initial warming of the passenger cabin to a predetermined temperature or set point as automatically or manually selected through the heating and ventilating and air conditioning (HVAC) system controls of the motor vehicle, the controller 50 sends a signal to the exhaust gas flow control valve actuator to place the exhaust gas flow control valve 30 at an intermediate position (see FIG. 4) so that exhaust gas flow from the engine 56 and catalytic converter 58 is split between the exhaust gas inlet conduit 22 leading to the exhaust gas and cabin air heat exchanger 12 and the exhaust gas discharge conduit 32 leading directly to the exhaust gas outlet 60. More specifically, the controller responds as necessary to the cabin air temperature as indicated by data received from the cabin air temperature monitor 54 and the exhaust gas temperature as indicated by data received from the exhaust gas temperature monitor 52 to maintain the desired predetermined or set point temperature for the passenger cabin of the motor vehicle.

In an alternative embodiment illustrated in FIG. 6, the apparatus 10 further includes a coolant and cabin air heat exchanger 70 for heat exchange between the engine coolant and the cabin air. Such a coolant and cabin air heat exchanger 70 is well-known in the art.

As illustrated in FIG. 6, the exhaust gas and cabin air heat exchanger 12 is provided in series and downstream from the coolant and cabin air heat exchanger 70. As further illustrated in the FIG. 6 embodiment, the cabin air circulation fan 40 is provided downstream from the two heat exchangers in the cabin air outlet conduit 38. Where the apparatus 10 includes both an exhaust gas and cabin air heat exchanger 12 and an engine coolant and cabin air heat exchanger 70, the controller 50 is configured to operate the apparatus 10 at peak efficiency based upon data input including but not limited to cabin air temperature data, exhaust gas temperature data, engine coolant temperature data (note coolant temperature monitor 72 used for this embodiment) and a desired or set point temperature for the cabin air through the HVAC system controls. Advantageously, the exhaust gas and cabin air heat exchanger 12 provides for rapid heating of the cabin air on cold winter mornings or at other times when the engine coolant must first warm from a low ambient temperature before the engine coolant and cabin air heat exchanger 70 can provide effective heating of the cabin air. Once the engine coolant has warmed sufficiently, the controller 50 may use both heat exchangers 12, 70 to warm the cabin air. Alternatively, the controller 50 may direct all heating of the cabin air to be completed by the coolant and cabin air heat exchanger 70 once the engine coolant has warmed sufficiently to efficiently and effectively perform this function. In such an instance, it is no longer necessary to divert any of the exhaust gases into the exhaust gas inlet conduit 22 from the exhaust gas discharge conduit 32 by the exhaust gas flow control valve 30.

Consistent with the above description, a method is provided of heating cabin air in a motor vehicle. That method includes the step of circulating exhaust gases and cabin air through an exhaust gas and cabin air heat exchanger 12 whereby heat is directly exchanged between the exhaust gases and the cabin air without use of any other working fluid.

The method may further include the step of diverting exhaust gases toward the exhaust gas and cabin air heat exchanger 12 by operation of an exhaust gas flow control valve 30. In addition, the method may include locating that exhaust gas flow control valve 30 downstream from the engine 56 and catalytic converter 58 of the motor vehicle where the diversion of exhaust gases will not compromise the normal after-treatment warmup process and environmental controls.

The method may also include configuring the controller 50 to control operation of the exhaust gas flow control valve 30. Further, the method may include circulating cabin air through the exhaust gas and cabin air heat exchanger 12 with a cabin air circulation fan 40. In such an embodiment, the method may further include the step of configuring the controller 50 to control operation of the cabin air circulation fan 40.

In one of many possible embodiments such as illustrated in FIGS. 1-5 and 7, the method may include exclusively heating the cabin air with exhaust gases in the exhaust gas and cabin air heat exchanger 12. In another possible embodiment such as illustrated in FIG. 6 and including the phantom line showing in FIG. 7, the method may include pairing the exhaust gas and cabin air heat exchanger 12 with a motor vehicle coolant and cabin air heat exchanger 70. In such an embodiment, the method may include configuring the controller 50 to heat the cabin air (a) with exhaust gases in the exhaust gas and cabin air heat exchanger 12 until the motor vehicle coolant reaches a predetermined temperature as indicated by the motor vehicle coolant temperature monitor 72 and (b) with the motor vehicle coolant in the motor vehicle coolant and cabin air heat exchanger 70 after the coolant reaches a predetermined temperature as indicated by the motor vehicle coolant temperature monitor.

The foregoing has been presented for purposes of illustration and description. It is not intended to be exhaustive or to limit the embodiments to the precise form disclosed. Obvious modifications and variations are possible in light of the above teachings. For example, FIG. 6 illustrates the exhaust gas and cabin air heat exchanger 12 and motor vehicle coolant and cabin air heat exchanger 70 in series. It should be appreciated that they could be provided in parallel with respect to the flow of cabin air. In such an embodiment, the controller 50 would be connected to a cabin air flow control valve 74 to direct cabin air through (a) the exhaust gas and cabin air heat exchanger 12 alone, (b) the motor vehicle coolant and cabin air heat exchanger 70 alone or (c) both the exhaust gas and cabin air heat exchanger 12 and the motor vehicle coolant and cabin air heat exchanger 70. All such modifications and variations are within the scope of the appended claims when interpreted in accordance with the breadth to which they are fairly, legally and equitably entitled.

What is claimed:

1. An apparatus, comprising:
an exhaust gas and cabin air heat exchanger having an exhaust gas inlet, an exhaust gas outlet, a cabin air inlet and a cabin air outlet whereby heat is directly exchanged between exhaust gases and cabin air of a motor vehicle.

2. The apparatus of claim 1, further including an exhaust gas inlet conduit having a first end connected to an exhaust gas conduit and a second end connected to said exhaust gas inlet.

3. The apparatus of claim 2, further including an exhaust gas flow control valve at said first end.

4. The apparatus of claim 3, further including an exhaust gas discharge conduit connected to said exhaust gas outlet.

5. The apparatus of claim 4, further including a cabin air inlet conduit connected to said cabin air inlet and a cabin air outlet conduit connected to said cabin air outlet.

6. The apparatus of claim 5, further including a cabin air circulation fan circulating cabin air through said cabin air inlet conduit, said exhaust gas and cabin air heat exchanger and said cabin air outlet conduit.

7. The apparatus of claim 6, further including a controller configured to control operation of said exhaust gas flow control valve.

8. The apparatus of claim 7, wherein said controller is further configured to control operation of said cabin air circulation fan.

9. The apparatus of claim 8, further including a cabin temperature monitor and an exhaust gas temperature monitor connected to said controller.

10. The apparatus of claim 9, wherein said exhaust gas flow control valve is downstream a catalytic converter of said motor vehicle.

11. The apparatus of claim 10, further including a coolant and cabin air heat exchanger.

12. A method of heating cabin air in a motor vehicle, comprising:
circulating exhaust gases and cabin air through an exhaust gas and cabin air heat exchanger whereby heat is directly exchanged between said exhaust gases and said cabin air without any other working fluid.

13. The method of claim 12, including diverting exhaust gases toward said exhaust gas and cabin air heat exchanger by operation of an exhaust gas flow control valve.

14. The method of claim 13, including locating said exhaust gas flow control valve downstream from a catalytic converter of said motor vehicle.

15. The method of claim 14, including configuring a controller to control operation of said exhaust gas flow control valve.

16. The method of claim 15, including circulating cabin air through said exhaust gas and cabin air heat exchanger with a cabin air circulation fan.

17. The method of claim 16, including configuring said controller to control operation of said cabin air circulation fan.

18. The method of claim 17, including exclusively heating said cabin air with exhaust gases in said exhaust gas and cabin air heat exchanger.

19. The method of claim 17, including pairing said exhaust gas and cabin air heat exchanger with a motor vehicle coolant and cabin air heat exchanger.

20. The method of claim 19, including configuring said controller to heat said cabin air (a) with exhaust gases in said exhaust gas and cabin air heat exchanger until a motor vehicle coolant reaches a predetermined temperature and (b) with said motor vehicle coolant in said motor vehicle coolant and cabin air heat exchanger after said motor vehicle coolant reaches said predetermined temperature.
